(19) United States
(12) Patent Application Publication
(10) Pub. No.: US 2016/0032068 A1
(43) Pub. Date: Feb. 4, 2016

(54) POLYAMIDE RESIN COMPOSITION FOR FOAM MOLDED BODY, AND FOAM MOLDED BODY OF POLYAMIDE RESIN COMPRISING SAME

(71) Applicant: TOYOBO CO., LTD., Osaka (JP)

(72) Inventors: Tomohide NAKAGAWA, Shiga (JP); Kazunari TANAKA, Shiga (JP)

(73) Assignee: TOYOBO CO., LTD., Osaka (JP)

(21) Appl. No.: 14/781,367

(22) PCT Filed: May 12, 2014
(86) PCT No.: PCT/JP2014/062564

§ 371 Date: Sep. 30, 2015

(30) Foreign Application Priority Data
May 15, 2013 (JP) 2013-102942

(51) Int. Cl. C08J 9/00; C08K 7/20; C08K 7/14; C08K 3/04

(52) U.S. Cl. CPC C08J 9/00; C08K 3/04; C08K 7/20; C08K 7/14; C08J 2377/02; C08K 2003/045

(57) ABSTRACT

The present invention relates to a polyamide resin composition for a foam molded body, comprising a crystalline polyamide resin (A), carbon black (B) which does not exhibit crystallization promoting action to said crystalline polyamide resin and an inorganic reinforcing material (C), wherein, when the total amount of (A), (B) and (C) is taken as 100% by mass, the composition comprises (A) and (B) in a rate of 60 to 90% by mass in terms of the sum thereof and comprises (C) in a rate of 10 to 40% by mass, and wherein melting point and crystallization temperature of said polyamide resin composition have a specific relationship. The above-mentioned polyamide resin composition can provide a polyamide foam molded body having light weight, high load bearing property and good molded appearance.

### TECHNICAL FIELD OF THE INVENTION

The present invention relates to a polyamide resin composition for a foam molded body which gives a polyamide foam molded body not only having light weight and high load bearing property but also having good molded appearance, by an easy molding method, without deteriorating excellent physical properties and heat resistance of polyamide resin. As a result, such polyamide resin composition for a foam molded body makes it possible to provide automobile parts having high functional properties.

### BACKGROUND ART

In designing of automobiles in recent years, various efforts have been done in order to reduce fuel consumption. Reduction of weight by means of replacing metal with resin is one of the most important problems to be achieved. As a means for achieving much more weight reduction of resin product, a foamed structural body is exemplified. However, in the case of polypropylene, polystyrene, polyethylene, etc. having low heat resistance, the material itself is deteriorated or softened in a use environment of 100° C. or higher whereby it is not possible to play a role as a load bearing structural body.

Polyamide is a resin being excellent in heat resistance and mechanical properties. Therefore, the problems can be solved if a foam molded body of polyamide having high foaming magnification and homogeneous foam layers can be prepared. However, solidifying speed of polyamide is relatively quick and it is not suitable for foam molding. Therefore, a foam molded body in such a level which can solve the problems is prepared only by such a means that crystallization temperature is lowered using non-crystalline polyamide or the like. In addition, it has been difficult to prepare a molded body having good appearance without lowering the crystallization temperature.

As a method for preparing a foamed product of polyamide, a method using a chemical foaming agent has been known in general. The chemical foaming method is such a method wherein a material resin is mixed with an organic foaming agent which is decomposed at a molding temperature and generates gas, and the resulting mixture is heated to a temperature higher than decomposition temperature of the foaming agent to conduct foam molding. In Patent Document 1, a ternary copolymer of polyamide is used and a foamed body of polyamide having specific gravity of 1.2 is prepared by means of chemical foaming. However, foaming magnification is low and an object of weight reduction cannot be fully achieved. As a method for preparing a foamed product other than the chemical foaming method, Patent Document 2 discloses that carbon dioxide is previously absorbed into a molded body of polyamide and heating is conducted in a subsequent step to give a foamed product of polyamide of two-fold foaming magnification. However, weight reduction is not fully achieved as well and, in addition, molding step and foaming step are substantially in separate steps whereby this method is not efficient. In Patent Document 3, there is disclosed a method for preparing a foam molded body of polyamide wherein supercritical fluid of nitrogen or carbon dioxide is dissolved in a melted resin and injection molding is conducted. However, foaming magnification is as low as 1.25 and no sufficient weight reduction can be achieved.

In Patent Document 4, there is prepared a foam molded body having minute average cell diameter. However, complicated equipment is necessary in order to prepare an aimed foam molded body. Thus, in addition to common injection molding machine, special injection plunger and special injection device are separately needed for preparing the aimed foam molded body. Moreover, in Examples thereof, resin material is limited to polystyrene resin which is relatively easy for foam molding even in the already-existing foam molding, and no good foam molded body can be easily prepared using polyamide. Similarly, in Patent Document 5, there is disclosed a method for preparing a foam molded body using inert gas in a critical state. When a melted resin filled in a metal mold becomes a predetermined viscoelastic state during a cooling process, the metal mold in a core side is moved in mold-opening direction and, at the same time, the inert gas in a critical state is directly infused into the resin in the metal mold to give a foam molded body. In the case of crystalline polyamide having quick solidifying rate, it is not possible in this method to achieve a condition for forming a homogeneous foamed cell.

In addition, when molded body in black color is to be prepared, it is usual that black pigment promotes crystallization and accelerates solidification whereby appearance of the foam molded body is significantly deteriorated. Moreover, due to the same reason, growth of a foamed layer is inhibited and no homogeneous foamed layer is prepared. Therefore, it is difficult to prepare a foam molded body of polyamide having good appearance, particularly in the case of foam molded body in black color.

### PRIOR ART DOCUMENTS

### Patent Documents

Patent Document 1: Japanese Patent Application Laid-Open (JP-A) No. 2009-249549
Patent Document 2: Japanese Patent Application Laid-Open (JP-A) No. 2006-35687
Patent Document 3: Japanese Patent Application Laid-Open (JP-A) No. 2005-126545
Patent Document 4: Japanese Patent Application Laid-Open (JP-A) No. 2006-69215
Patent Document 5: Japanese Patent Application Laid-Open (JP-A) No. 2006-212945

### DISCLOSURE OF THE INVENTION

### Problem that the Invention is to Solve

An object of the present invention is not only to provide a foam molded body of polyamide having higher foaming magnification but also to easily provide a foam molded body of polyamide in black color which can give homogeneous foaming structure and good black surface appearance in spite of having a high foaming magnification and which also has useful properties of a foam molded body having a homogeneous foamed layer or, in other words, heat resistance, heat insulation property and, further, good anti-vibration property.

### Means for Solving the Problem

In order to achieve the above-mentioned object, the present inventors have chosen a black pigment which does not promote crystallization as a black pigment to be added to polyamide resin whereby a melted state in a metal mold is adjusted. The present inventors have found that, as a result thereof, melting viscosity is appropriately adjusted to give a homogeneous foamed structure in such a process wherein a chemical foaming agent and/or inert gas in a supercritical state are/is injected together with the resin in a melted state and filled into a cavity and, immediately after the injection molding, core part of a metal mold is moved backward so as to expand the cavity. The present inventors have also found that, as a result of non-promotion of the crystallization, solidifying speed becomes slow and good appearance can be achieved even in a non-foamed skin layer to which no pressure for keeping is applied due to the process of cavity expansion. Moreover, according to this method, stability of viscosity and crystallization temperature due to retention are significantly improved as compared with the method wherein crystallization temperature is lowered by blending with non-crystalline polyamide and as compared with the case wherein viscosity is adjusted using a polyfunctional compound in order to achieve a melting viscosity upon foaming. Therefore, the present inventors have found that, according to this method, it is possible to prepare a foam molded body of polyamide in black color most easily whereby the present invention has been accomplished.

Thus, in accordance with the present invention, there are provided the following constitutions.

(1) A polyamide resin composition for a foam molded body, comprising a crystalline polyamide resin (A), carbon black (B) which does not exhibit crystallization promoting action to said crystalline polyamide resin and an inorganic reinforcing material (C), wherein, when the total amount of (A), (B) and (C) is taken as 100% by mass, the composition comprises (A) and (B) in a rate of 60 to 90% by mass in terms of the sum thereof and comprises (C) in a rate of 10 to 40% by mass, and wherein said polyamide resin composition satisfies the following characteristic property (a):

characteristic property(a):X−Y≧37° C.

wherein X is melting point (° C.) in DSC measurement (raising rate of temperature: 20° C./minute) of the polyamide resin composition; and

Y is crystallization temperature (Tc2) (° C.) in DSC measurement (lowering rate of temperature: 20° C./minute) of the polyamide resin composition.

(2) The polyamide resin composition for a foam molded body according to (1), wherein the crystalline polyamide resin (A) is an aliphatic polyamide resin.

(3) The polyamide resin composition for a foam molded body according to (1) or (2), wherein Y (Tc2) in the characteristic property (a) is 182 to 186° C.

(4) The polyamide resin composition for a foam molded body according to any of (1) to (3), wherein the carbon black (B) is a black pigment which does not promote crystallization of the polyamide even when it is added in an amount of 0.1% by mass or more.

(5) A foam molded body of polyamide resin prepared using the polyamide resin composition for a foam molded body mentioned in any of (1) to (4).

(6) A foam molded body of polyamide resin prepared by such means that the polyamide resin composition for a foam molded body mentioned in any of (1) to (4) is melted, the polyamide resin composition in a melted state is injected and filled into a cavity formed of clamped plural metal molds together with chemical foaming agent and/or inert gas in a supercritical state, at least one metal mold in a core side is moved in a mold-opening direction at the stage when non-foamed skin layer is formed by an injecting outer pressure and a foaming pressure from inside, and volume of the cavity is expanded to volume of a foam molded body.

(7) The foam molded body of polyamide resin according to (5) or (6), wherein the foam molded body of polyamide resin is for automobile-related parts.

(8) The foam molded body of polyamide resin according to (7), wherein the automobile-related parts are one member selected from interior equipment, exterior equipment, covers, case and load-supporting parts.

(9) The foam molded body of polyamide resin according to (7), wherein the automobile-related parts are heat-resisting covers which are any of engine cover, cylinder head cover and transmission cover.

### Advantages of the Invention

The polyamide foam molded body in black color having good appearance prepared by the present invention is a polyamide resin structure not only having light weight and high mechanical properties but also having homogeneous foaming state and good surface appearance in spite of its high foaming magnification and exhibiting heat insulation effect and anti-vibration property. Accordingly, in accordance with the present invention, it is now possible to provide a heat insulation foam molded body of polyamide which is applicable even to functional resin parts being demanded for high properties and also to design parts being demanded for functionality.

### BRIEF DESCRIPTION OF THE DRAWINGS

FIG. 1 is an example (Example 1) of cross section of a foam molded body of polyamide resin according to the present invention.

FIG. 2 is a brief constitutional drawing which shows a method for preparing a foam molded body of polyamide resin according to the present invention.

### BEST MODE FOR CARRYING OUT THE INVENTION

As hereunder, the polyamide resin composition of the present invention and the foam molded body using the same will be illustrated in detail.

The crystalline polyamide resin (A) to be used in the present invention is a polyamide resin produced by polycondensation of lactam, ω-aminocarboxylic acid, dicarboxylic acid, diamine, etc. as materials or is a copolymerized product or a blended product thereof. Specific examples of amine component are an aliphatic diamine such as 1,2-ethylenediamine, 1,3-trimethylenediamine, 1,4-tetra-methylenediamine, 1,5-pentamethylenediamine, 2-methyl-1,5-pentamethylenediamine, 1,6-hexamethylenediamine, 1,7-heptamethylenediamine, 1,8-octamethylenediamine, 1,9-nonamethylenediamine, 2-methyl-1,8-octamethylenediamine, 1,10-decamethylenediamine, 1,11-undecamethylenediamine, 1,12-dodecamethylenediamine, 1,1,3-tridecamethylenediamine, 1,16-hexadecamethylenediamine, 1,18-octadecamethylenediamine or 2,2,4(or 2,4,4)-trimethyl-hexamethylenediamine; an alicyclic diamine such as piperazine, cyclohexanediamine, bis(3-methyl-4-aminohexyl)methane, bis-(4,4′-amino-cyclohexyl)methane or isophoronediamine; an aromatic diamine such as m-xylylenediamine, p-xylylenediamine, p-phenylenediamine or m-phenylenediamine; and a hydrogenated product thereof. As to an acid component of the polyamide, the following polycarboxylic acid or acid anhydride may be used. Examples of the polycarboxylic acid are an aromatic dicarboxylic acid such as terephthalic acid, isophthalic acid, orthophthalic acid, 1,5-naphthalenedicarboxylic acid, 2,6-naphthalenedicarboxylic acid, 4,4′-dipenyldicarboxylic acid, 2,2′-diphenyldicarboxylic acid, 4,4′-diphenylether dicarboxylic acid, 5-(sodium sulfonate)isophthalic acid or 5-hydroxyisophthalic acid; and an aliphatic or alicyclic dicabroxylic acid such as fumaric acid, maleic acid, succinic acid, itaconic acid, adipic acid, azelaic acid, sebacic acid, 1,11-undecanoic diacid, 1,12-dodecanoic diacid, 1,14-tetradecanoic diacid, 1,18-octadecanoic diacid, 1,4-cyclohexanedicarboxylic acid, 1,3-cyclohexanedicarboxylic acid, 1,2-cyclohexanedicarboxylic acid, 4-methyl-1,2-cyclohexanedicarboxylic acid or dimer acid.

Additional examples are a lactam such as ε-caprolactam as well as aminocarboxylic acid, undecane lactam and lauryl lactam having a structure wherein the ring hereinabove is open and 11-aminoundecanoic acid, 12-aminododecanoic acid, etc. having a structure wherein the ring hereinabove is open. Examples of polyamide polymerized from those components are polycaproamide (Polyamide 6), polyundecamide (Polyamide 11), polylauramide (Polyamide 12), polytetramethylene adipamide (Polyamide 46), polyhexamethylene adipamide (Polyamide 66), polyundecamethylene adipamide (Polyamide 116), poly-m-xylylene adipamide (Polyamide MXD 6), poly-p-xylylene adipamide (Polyamide PXD 6), polytetramethylene sebacamide (Polyamide 410), polyhexamethylene sebacamide (Polyamide 610), polydecamethylene adipamide (Polyamide 106), polydecamethylene sebacamide (Polyamide 1010), polyhexamethylene dodecamide (Polyamide 612), polydecamethylene dodecamide (Polyamide 1012), polyhexamethylene isophthalamide (Polyamide 61), polytetramethylene terephthalamide (Polyamide 4T), polypentamethylene terephthalamide (Polyamide 5T), poly-2-methyl-pentamethylene terephthalamide (Polyamide M-5T), polyhexamethylene terephthalamide (Polyamide 6T), polyhexamethylene hexahydroterephthalamide (Polyamide 6T (H)), polynonamethylene terephthalamide (Polyamide 9T), polyundecamethylene terephthalamide (Polyamide 11T), polydecamethylene terephthalamide (Polyamide 12T), polybis(3-methyl-4-aminohexyl)methane terephthalamide (Polyamide PACMT), polybis-(3-methyl-4-aminohexyl)methane isophthalamide (Polyamide PACMI), polybis(3-methyl-4-aminohexyl)methane dodecamide (Polyamide PACM 12) and polybis(3-methyl-4-aminohexyl)-methane tetradecamide (Polyamide PACM 14). With regard to crystalline polyamide resin (A), there are exemplified the above polyamide group and/or copolymer thereof and/or blended composition thereof.

A matrix polyamide resin of the polyamide resin composition used in the present invention is preferred to be a crystalline polyamide resin and, among the above, an aliphatic polyamide resin is more preferred. More preferably it is Polyamide 6.

Crystallization speed of Polyamide 6 can be evaluated using crystallization temperature (Tc2) upon lowering of temperature in DSC as an index. The Tc2 of Polyamide 6 immediately after polymerization at 10° C./minute is 179 to 175° C. When the Polyamide 6 is kneaded using a biaxial extruder after addition of, for example, glass fiber (GF) thereto, the Tc2 of the pellets (polyamide resin composition) after the kneading rises up to about 188 to 190° C. When carbon black of a furnace type which is commonly used as a universal carbon black is added, the Tc2 is 191 to 194° C. or higher and it is not possible to adjust the Tc2 to 190° C. or lower.

If the Tc2 of the resin composition to be used in the present invention becomes to be 190° C. or higher under a temperature lowering condition of 10° C./minute when the crystalline polyamide resin (A) is Polyamide 6, crystallization occurs too quick and it is not possible to prepare a good foamed layer by means of foam molding using cavity expansion. In the foam molding using cavity expansion, preferred Tc2 of the resin composition to be used in the present invention is within a range of 185 to 189° C. under a temperature lowering condition of 10° C./minute and more preferably within a range of 182 to 186° C. under a temperature lowering condition of 20° C./minute.

Relative viscosity (RV) of the crystalline polyamide resin (A) to be used in the present invention measured in 96% concentrated sulfuric acid at 20° C. is preferred to be 1.5 to 2.8, more preferred to be 1.6 to 2.7, and most preferred to be 1.6 to 2.5. As to a method for making relative viscosity of the polyamide within a predetermined range, a means for adjusting molecular weight is exemplified. The polyamide having relative viscosity of less than 1.5 shows good fluidity but its physical property is bad. The polyamide having relative viscosity of more than 2.8 is not preferred since it is hard to flow particularly in a thin molding of 2.0 mm or less.

In the crystalline polyamide resin (A) used in the present invention, terminal group amount and molecular weight of the polyamide can be adjusted by a method wherein polycondensation is carried out by adjusting molar ratio of amino group to carboxyl group or by a method wherein a terminal blocking agent is added. When polycondensation is carried out in a predetermined rate of the molar ratio of amino group to carboxyl group, it is preferred that the molar ratio of the total diamine to the total dicarboxylic acid used therefor is adjusted within such a range wherein diamine/dicarboxylic acid is from 1.00/1.05 to 1.10/1.00.

When terminal of the crystalline polyamide resin (A) is blocked, the timing for adding a terminal blocking agent may be a stage when the material is charged, a stage when the polymerization is initiated, a latter stage of the polymerization or a stage when the polymerization finishes. There is no particular limitation for the terminal blocking agent so far as it is a monofunctional compound which is reactive to amino group or carboxyl group of the polyamide terminal. Examples thereof are monocarboxylic acid, monoamine, acid anhydride (such as phthalic anhydride), monoisocyanate, monoacid halide, monoester and monoalcohol. Specific examples of the terminal blocking agent are an aliphatic monocarboxylic acid such as acetic acid, propionic acid, butyric acid, valeric acid, caproic acid, caprylic acid, lauric acid, tridecanoic acid, myristic acid, palmitic acid, stearic acid, pivalic acid or isovaleric acid; an alicyclic monocarboxylic acid such as cyclohexanecarboxylic acid; an aromatic monocarboxylic acid such as benzoic acid, toluic acid, α-naphthalenecarboxylic acid, β-naphthalenecarboxylic acid, methylnaphthalenecarboxylic acid or phenylacetic acid; an acid anhydride such as maleic anhydride, phthalic anhydride or hexahydrophthalic anhydride; an aliphatic monoamine such as methylamine, ethylamine, propylamine, butylamine, hexylamine, octylamine, decylamine, stearylamine, dimethylamine, diethylamine, dipropylamine or dibutylamine; an alicyclic monoamine such as cyclohexylamine or dicyclohexylamine; an aromatic monoamine such as aniline, toluidine, diphenylamine or naphthylamine; etc.

Acid value and amine value of the crystalline polyamide resin (A) used in the present invention are preferred to be 0 to 200 eq/ton and 0 to 100 eq/ton, respectively. When terminal functional group is more than 200 eq/ton, not only gelling and deterioration are promoted during the melt retention but also problems such as coloration and hydrolysis may happen even under the using environment. On the other hand, when a reactive compound such as glass fiber or maleic acid-modified polyolefin is compounded, it is preferred that acid value and/or amine value are/is made 5 to 100 eq/ton so as to bring into line with reactivity and reactive group.

Carbon black (B) (hereinafter, it will be sometimes referred to as special carbon black) which does not exhibit crystallization promoting action to the crystalline polyamide resin (A) used in the present invention is such a thing which does not rise the Tc2 of a polyamide resin composition prepared by melting and kneading of both of them. To be more specific, preferred one is such a carbon black wherein the Tc2 becomes 185 to 190° C. when the Tc2 is measured under a temperature-lowering condition of 10° C./minute in DSC evaluation for pellets (polyamide resin composition) prepared by adding carbon black (B) to Polyamide 6 during melting and kneading. Further, more preferred one is such a carbon black wherein the Tc2 becomes 182 to 186° C. when the Tc2 is measured under a temperature-lowering condition of 20° C./minute in DSC evaluation. Since the carbon black (B) which does not exhibit crystallization promoting action to the crystalline polyamide used in the present invention does not act on the DSC melting point, it is most desirable as a result that the polyamide resin composition used in the present invention satisfies the following characteristic property (a):

characteristic property(a):X−Y≧37° C.

wherein X is melting point (° C.) in DSC measurement (temperature-rising rate: 20° C./minute) of the polyamide resin composition; and

Y is crystallization temperature (Tc2) (° C.) in DSC measurement (temperature-lowering rate: 20° C./minute of the polyamide resin composition.

As to the carbon black (B) which does not exhibit crystallization promoting action to the polyamide resin used in the present invention, it is preferred to be a black pigment which does not promote crystallization of the polyamide even when it is added in an amount of 0.1% by mass or more. For example, it is preferred to be such a carbon black wherein the Tc2 becomes 182 to 186° C. when the Tc2 is measured under a temperature-lowering condition of 20° C./minute in DSC evaluation of a polyamide resin composition comprising 69 parts by mass of Polyamide 6 (A), 1 part by mass of the carbon black (B) and 30 parts by mass of an inorganic reinforcing material (C).

Commonly used carbon black is furnace black. As to a method for producing carbon black species, the following descriptions are generally known. The carbon black which is produced by a furnace method which is the main stream at present is called “furnace black” and is discriminated from those which are produced by other methods. A furnace black-furnace method is such a method wherein oil of petroleum type or coal type as a material is blown into a high-temperature gas and is subjected to incomplete combustion to produce carbon black. This method exhibits high yield and is suitable for a large scale production. Moreover, this method makes it possible to control particle size, structure, etc. within a broad range. Accordingly, this method is mostly frequently used for the production of carbon black for various uses including reinforcement of rubber and coloration. A channel black-channel method is such a method wherein natural gas is mostly used as a material, flame in incomplete combustion is made to contact with channel steel (steel in H type) and carbon black separated out therefrom is scraped and collected. Since there is a problem in terms of yield and environment therein, the furnace method is a mainstream as a process for a large scale production. An acetylene black-acetylene method is such a method wherein carbon black is produced by thermal decomposition of acetylene gas. According to this method, carbon black having high structure and high crystallinity can be prepared. The carbon black prepared thereby is mostly used as an agent for imparting electric conductivity. A lamp smoke black (lamp black) method is such a method wherein carbon black is recovered as soot from the smoke generated in burning of oil or pine and is a method which has been continuously used since the era of before Christ. Although it is not suitable for a large scale production, carbon black having a unique color tone is prepared by this method. The carbon black prepared thereby is used as a material for solid ink sticks, etc.

As to the carbon black (B) used in the present invention which does not rise the Tc2 of a polyamide resin composition in an injection molding process thereof, wherein the polyamide resin composition has been added in a melting and kneading process, a carbon black which is not produced by the furnace method is preferred. More preferred ones are those which are not produced by the furnace method and by the lamp smoke method. Although there are disclosed in several patents and documents that pigments of a nigrosin type have an effect of coloring in black and an effect of lowering the crystallization rate, such pigments are not preferred in view of bleeding, Tc2 controlling property to aimed color and cost.

As to the carbon black (B) which does not exhibit crystallization promoting action to the crystalline polyamide resin used in the present invention, “EPC 840 manufactured by Sumika Color” (master base: LDPE resin) and “PEC-TT1617 manufactured by Resino Color” (master base: LDPE resin) have been commercially available as carbon black master batches and can be used.

In the present invention, the amount of the carbon black (B) to the total amount of the crystalline polyamide resin (A) and the carbon black (B) is preferred to be from 0.1 to 10.0% by mass, more preferred to be from 0.2 to 5.0% by mass, most preferred to be from 0.5 to 4.0% by mass, and particularly preferred to be from 1.0 to 3.0% by mass. When the adding amount of the carbon black (B) is less than 0.1% by mass, its masking property by black color is not sufficient while, when it is more than 10% by mass, mechanical properties are deteriorated whereby they are not preferred.

A fibrous inorganic reinforcing material as an inorganic reinforcing material (C) used in the present invention most effectively improves strength and physical properties such as rigidity and heat resistance. Specific examples thereof are a fibrous thing such as glass fiber, carbon fiber, aramid fiber, alumina fiber, silicon carbide fiber or zirconia fiber; whisker such as aluminum borate or potassium titanate; needle-shaped wollastonite; milled fiber; etc. though the present invention is not limited thereto.

Among those fibrous reinforcing materials, glass fiber, carbon fiber, etc. are used particularly preferably. In the fibrous reinforcing materials as such, those which are previously treated with a coupling agent such as organic silane compound, organic titanium compound, organic borane compound or epoxy compound are preferred and those which are apt to react with a carboxylic acid group or/and a carboxylic acid anhydride group are particularly preferred. A polyamide resin composition compounded with a glass fiber which is previously treated with a coupling agent is preferred since it is possible to give a molded body having excellent mechanical properties and appearance properties. Even other fibrous reinforcing agent wherein no treatment with a coupling agent is done yet may be used after the coupling agent is added thereto.

As to a glass fiber, that in a chopped strand shape being cut into the fiber length of about 1 to 20 mm is used preferably. As to a cross-sectional shape of a glass fiber, glass fiber in a circular cross section and in a non-circular cross section may be used. The glass fiber in a non-circular cross section includes the one wherein the cross section being vertical to the lengthwise direction of the fiber is nearly elliptic, nearly long circular or nearly cocoon shapes. Flatness degree thereof is preferably 1.5 to 8. Here, the term “flatness degree” is ratio of long diameter to short diameter when a rectangle with the smallest area contacting the outside of the cross section vertical to the lengthwise direction of the glass fiber is supposed and the length of the long side of this rectangle is named the long diameter and the length of the short side thereof is named the short diameter. Although there is no particular limitation for the diameters of the glass fiber, the short diameter and the long diameter are about 1 to 20 μm and 2 to 100 μm, respectively. As to the adding amount of the reinforcing material, an optimum amount may be selected. When the total amount of crystalline polyamide resin (A), carbon black (B) and inorganic reinforcing material (C) is taken as 100% by mass, it is possible to add in such a manner that a compounding amount of the sum of (A) and (B) is 60 to 90% by mass and that of (C) is 10 to 40% by mass. When the compounding amount of (C) is more than 40% by mass, an amount of the matrix resin is small whereby it is not possible to spread melted resin upon foaming and to achieve homogeneous foamed state and good appearance of molded body only by means of viscosity adjustment and crystallization using the crystalline polyamide and the specific carbon black. The compounding amount of (C) is preferred to be 12 to 38% by mass and more preferred to be 15 to 35% by mass.

Further, to the polyamide resin composition of the present invention, it is also possible to add a filler as (C) besides the above fibrous reinforcing agent. Examples of the filler are glass beads, glass flakes, glass balloons, silica, talc, kaolin, wollastonite, mica, alumina, hydrotalcite, montmorillonite, graphite, carbon nanotube, fullerene, zinc oxide, indium oxide, tin oxide, iron oxide, titanium oxide, magnesium oxide, aluminum hydroxide, magnesium hydroxide, red phosphorus, calcium carbonate, potassium titanate, lead titanate zirconate, barium titanate, aluminum nitride, boron nitride, zinc borate, aluminum borate, barium sulfate, magnesium sulfate and layered silicate subjected to an organic treatment for a purpose of interlayer exfoliation. With regard to the fillers as such, only one kind thereof may be used solely or plural ones may be used in combination. As to the adding amount of the filler, an optimum amount may be selected. When the total amount of crystalline polyamide resin (A), carbon black (B) and inorganic reinforcing material (C) is taken as 100% by mass, it is possible to add in such a manner that a compounding amount of the sum of (A) and (B) is 60 to 90% by mass and that of (C) is 10 to 40% by mass. The compounding amount of (C) is preferred to be 12 to 38% by mass and more preferred to be 15 to 35% by mass. Moreover, with regard to the fibrous reinforcing agent and the filler, it is preferred, for improving affinity with the polyamide resin, to use those which are previously subjected to a treatment with a coupling agent or to use them together with the coupling agent. As to the coupling agent, any of a silane-type coupling agent, a titanate-type coupling agent and an aluminum-type coupling agent may be used. Among them, an aminosilane coupling agent and an epoxysilane coupling agent are particularly preferred.

In the present invention, it is also possible to add an olefin polymer having a carboxylic acid group and/or a carboxylic acid anhydride group for an object of imparting impact resistance to the polyamide. Such an additive is a polymer or a copolymer of a-olefin wherein a monomer having a carboxylic acid group or/and a carboxylic acid anhydride group is contained in a polymer molecular chain by means of copolymerization, graft polymerization, etc. The polymer as such for imparting the impact resistance may be added in an amount of 0 to 20 part(s) by mass to 100 parts by mass of the crystalline polyamide resin (A).

Specific examples of the olefin polymer include polyolefin prepared by radical polymerization of at least one member of a homopolymer (such as polyethylene, polypropylene, polybutene-1, polypentene-1 or polymethylpentene), an a-olefin (such as ethylene, propylene, butane-1, pentene-1,4-methylpentene-1, hexene-1, octene-1 or isobutylene), a non-conjugated diene (such as 1,4-hexadienedicyclopentadiene, 2,5-norbornadiene, 5-ethylidenenorbornene, 5-ethyl-2,5-norbornadiene or 5-(1′-propenyl)-2-norborene), etc. using a common metal catalyst or a metallocene-type highly efficient catalyst.

As to a diene-type elastomer, there is a block copolymer elastomer in an A-B type or an A-B-A′ type consisting of a vinyl-type aromatic hydrocarbon and a conjugated diene wherein the terminal block A and A′ may be same or different, and a thermoplastic homopolymer or copolymer derived from a vinyl-type aromatic hydrocarbon whose aromatic moiety may be either monocyclic or polycyclic. Examples of the vinyl-type aromatic hydrocarbon as such are styrene, α-methylstyrene, vinyltoluene, vinylxylene, ethylvinylxylene, vinylnaphthalene and a mixture thereof. As to the intermediate polymer block B, examples thereof are polymers comprising a conjugated diene-type hydrocarbon being derived from, for example, 1,3-butadiene, 2,3-dimethylbutadiene, isoprene, 1,3-pentadiene or a mixture thereof. The present invention also covers a case wherein the intermediate polymer block B of the above block copolymer is subjected to a hydrogenation treatment.

Specific examples of the polyolefin copolymer are ethylene/propylene copolymer, ethylene/butene-1 copolymer, ethylene/hexene-1 copolymer, ethylene/propylene/dicyclopentadiene copolymer, ethylene/propylene/5-ethylidene-2-norbornene copolymer, non-hydrogenated or hydrogenated polybutadiene, non-hydrogenated or hydrogenated styrene/isoprene/styrene tri-block copolymer and non-hydrogenated or hydrogenated styrene/butadiene/styrene tri-block copolymer.

There is no particular limitation for a method of introducing a carboxylic acid group or/and a carboxylic acid anhydride group. There may be used, for example, a method wherein a graft is introduced into a copolymerized or a non-modified polyolefin using a radical initiator. With regard to the introducing amount of the functional group-containing component as such, it is appropriate to be 0.1 to 20 molar % and preferably 0.5 to 12 molar % to the whole olefin monomers in the modified polyolefin in the case of copolymerization while, in the case of graft, it is appropriate to be 0.1 to 10% by mass and preferably 0.5 to 6% by mass to the mass of the modified polyolefin. When the introducing amount of the functional group-containing component is less than the above-mentioned range, there may be the case wherein reaction is insufficient and impact resistance is not fully imparted while, when it is more than the above-mentioned range, there may be the case wherein stability of melt viscosity is deteriorated.

Specific examples of the above-mentioned modified polyolefin are maleic acid anhydride-modified polyethylene, maleic acid anhydride-modified polypropylene, ethylene/acrylic acid copolymer, ethylene/methacrylic acid copolymer (as well as such ones wherein a part of or all of the carboxylic acid moiety/moieties in the above copolymer is/are made into a salt with sodium, lithium, potassium, zinc or calcium), ethylene/methyl acrylate copolymer, ethylene/ethyl acrylate copolymer, ethylene/methyl methacrylate copolymer, ethylene/ethyl methacrylate copolymer, ethylene/ethyl acrylate-g-maleic acid anhydride copolymer (“g” stands for graft; hereinafter, it stands for the same), ethylene/methyl methacrylate-g-maleic acid anhydride copolymer, ethylene/propylene-g-maleic acid anhydride copolymer, ethylene/butene-1-g-maleic acid anhydride copolymer, ethylene/propylene/1,4-hexadiene-g-maleic acid anhydride copolymer, ethylene/propylene/dicyclopentadiene-g-maleic acid anhydride copolymer, ethylene/propylene/2,5-norbornadiene-g-maleic acid anhydride copolymer, hydrogenated styrene/butadiene/styrene-g-maleic acid anhydride copolymer and hydrogenated styrene/isoprene/styrene-g-maleic acid anhydride copolymer.

Among them, polymers and copolymers having a carboxylic acid anhydride group which is highly reactive to amine in the polyamide are preferred.

In addition to the above-mentioned ones, various conventional additives for polyamide may be added to the polyamide resin composition of the present invention. Examples of the additive are stabilizer, impact improving agent, flame retardant, mold-releasing agent, slidability improving agent, coloring agent, plasticizer, crystal nucleus agent, polyamide which is different from the crystalline polyamide resin (A) used in the present invention and thermoplastic resin except polyamide.

Although a preferred adding amount of each of the additives is as shown below, the total amount of the crystalline polyamide resin (A), the specific carbon black (B) and the inorganic reinforcing material (C) which are essential components is preferred to occupy 80% by mass or more, more preferred to occupy 90% by mass or more, and most preferred to occupy 95% by mass or more of the polyamide resin composition of the present invention.

As to the stabilizer, there are exemplified an organic type antioxidant or thermostabilizer such as hindered phenol-type antioxidant, sulfur-type antioxidant or phosphorus-type antioxidant; a light stabilizer or ultraviolet absorber such as that of hindered amine type, benzophenone type or imidazole type; a metal inactivating agent; a copper compound; etc. As to the copper compound, there may be used cuprous chloride, cuprous bromide, cuprous iodide, cupric chloride, cupric bromide, cupric iodide, cupric phosphate, cupric pyrophosphate, copper sulfide, copper nitrate, a copper salt of an organic carboxylic acid such as copper acetate, etc. As to the constituent component other than a copper compound, it is preferred to contain an alkali metal halide compound. Examples of the alkali metal halide compound are lithium chloride, lithium bromide, lithium iodide, sodium fluoride, sodium chloride, sodium bromide, sodium iodide, potassium fluoride, potassium chloride, potassium bromide, potassium iodide, etc. Each of those additives may be used solely or several of them may be used in a combination thereof. As to the adding amount of the stabilizer, optimum amount may be selected and it is possible to add 0 to 5 part(s) by mass of the stabilizer to 100 parts by mass of the crystalline polyamide resin (A).

A thermoplastic resin other than polyamide may also be added to the polyamide resin composition of the present invention within such an extent that it does not deteriorate the effect of the present invention. Examples of the polymer other than polyamide are polyphenylene sulfide (PPS), liquid crystal polymer (LCP), aramid resin, polyether ether ketone (PEEK), polyether ketone (PEK), polyether imide (PEI), thermoplastic polyimide, polyamide imide (PAI), polyether ketone ketone (PEKK), polyphenylene ether (PPE), polyether sulfone (PES), polysulfone (PSU), polyarylate (PAR), polyethylene terephthalate, polybutylene terephthalate, polyethylene naphthalate, polybutylene naphthalate, polycarbonate (PC), polyoxymethylene (POM), polypropylene (PP), polyethylene (PE), polymethylpentene (TPX), polystyrene (PS), poly(methyl methacrylate), acrylonitrile-styrene copolymer (AS) and acrylonitrile-butadiene-styrene copolymer (ABS). When compatibility is bad, it is important to add a compatibilizer such as reactive compound or block polymer, or to modify a polymer other than polyamide (acid modification is particularly preferred). Although it is possible to blend the thermoplastic resin as such in a melted state by means of melting/kneading, it is also possible to make the thermoplastic resin into fibers or particles and to disperse them in the polyamide resin (A) used in the present invention. As to the adding amount of the thermoplastic resin, optimum amount may be selected and it is possible to add 0 to 50 part(s) by mass of the thermoplastic resin to 100 parts by mass of the crystalline polyamide resin (A).

When flame-resistance property is imparted to the polyamide resin composition of the present invention within such an extent that the effect of the present invention is not deteriorated, a combination of halogen-type flame retardant with antimony is good as a flame retardant. As to the halogen-type flame retardant, preferred ones are brominated polystyrene, brominated polyphenylene ether, brominated bisphenol-type epoxy polymer, brominated styrene maleic acid anhydride polymer, brominated epoxy resin, brominated phenoxy resin, decabromodiphenyl ether, decabromobiphenyl, brominated polycarbonate, perchlorocyclopentadecane, brominated cross-linked aromatic polymer, etc. As to the antimony compound, preferred ones are antimony trioxide, antimony pentaoxide, sodium antimonate, etc. A combination of dibromopolystyrene with antimony trioxide is particularly preferred in view of thermostability. As to a non-halogen type flame retardant, there are exemplified melamine cyanurate, red phosphorus, metal salt of phosphinic acid and nitrogen-containing phosphoric acid-type compound. A combination of the metal salt of phosphinic acid with the nitrogen-containing phosphoric acid-type compound is particularly preferred. The nitrogen-containing phosphoric acid-type compound includes a reaction product or a mixture of melamine or melamine condensate such as melame or melone with polyphosphoric acid. At that time, it is preferred to add a hydrotalcite-type compound as preventer for corrosion of metal such as a metal mold. As to the adding amount of the flame retardant, optimum amount may be selected and it is possible to add 0 to 50 part (s) by mass of the flame retardant to 100 parts by mass of the crystalline polyamide resin (A).

Examples of a mold-releasing agent to be added in the present invention are long-chain fatty acid or ester or metal salt thereof, amide-type compound, polyethylene wax, silicone and polyethylene oxide. As to the long-chain fatty acid, that having 12 or more carbon number is particularly preferred. Examples thereof are stearic acid, 12-hydroxystearic acid, behenic acid and montanic acid wherein a part of or all of the carboxylic acids may be esterified by monoglycol or polyglycol or may form a metal salt. Examples of the amide-type compound are ethylenebisterephthalamide and methylenebisstearylamide. The mold-releasing agent as such may be used either solely or jointly as a mixture thereof. As to the adding amount of the mold-releasing agent, optimum amount may be selected and it is possible to add 0 to 5 part (s) by mass of the mold-releasing agent to 100 parts by mass of the crystalline polyamide resin (A).

When slidability property is to be enhanced in the present invention, examples of a slidability improving agent used therefor are high-molecular polyethylene, acid-modified high-molecular polyethylene, fluorine resin powder, molybdenum disulfide, silicone resin, silicone oil, zinc, graphite and mineral oil. The slidability improving agent may be added within such an extent that the characteristic property of the present invention is not deteriorated and, for example, within a range of 0.05 to 3 part (s) by mass to 100 parts by mass of crystalline polyamide resin (A).

In the polyamide resin composition used in the present invention, it is useful to add a heat-resisting agent for the sake of heat-resisting stability of the polyamide resin composition when the composition is retained for long time in a melted state at high temperature during the foam molding. As to a preventer for long-term thermal aging being effective under a high-temperature environment of 120° C. or higher, there may be used a copper compound such as copper acetate or copper halide (e.g., copper iodide, copper chloride or copper bromide). Adding amount of the copper compound is preferred to be 0.005 to 0.5 part by mass and more preferred to be 0.01 to 0.5 part by mass to 100 parts by mass of the crystalline polyamide resin (A).

As to the copper compound, a joint use with an alkali halide such as potassium iodide, potassium chloride or sodium iodide is also effective. As to other heat-resisting agent, it is also possible to use an antioxidant or an oxidation preventer such as phosphorus-type preventer, hindered phenol-type compound, phosphite compound or thioether-type compound within a known range.

When the polyamide resin composition used in the present invention is colored into black using the specific carbon black (B) upon melting and kneading of the crystalline polyamide resin (A) with the inorganic reinforcing material (C), the Tc2 of the polyamide resin composition can be suppressed to a range of 185 to 189° C. under a temperature-lowering condition of 10° C./minute in DSC measurement. As a state being more suitable for foam molding, it can be adjusted to the range of the Tc2=182 to 186° C. under the preferred temperature-lowering condition of 20° C./minute. In the polyamide resin composition adjusted as such, a suitable melted state can be retained until the foaming process finishes during a process from the melted state to the solidification in a metal mold and, in addition, even under a low metal mold transfer pressure to which only inner pressure by a foaming agent is contributed, good appearance state in black color can be achieved whereby, in a cavity expansion foam molding, it is possible to achieve good appearance in black color and a homogeneous foamed layer.

As to the foam molded body of the present invention, it is preferred to be such a foam molded body which has specific gravity of 0.2 to 1.0, has a non-foamed skin layer of 100 to 800 μm in a surface layer, and has a foamed layer comprising foamed cells of 10 to 300 μm average cell diameter in an inner layer, wherein said foamed cells are independent of a continued phase of resin and wherein the foamed layer is sandwiched by the non-foamed structure. It is more preferred to be such a foam molded body which has specific gravity of 0.25 to 0.9, has a non-foamed skin layer of 150 to 600 μm in a surface layer, and has a foamed layer comprising foamed cells of 30 to 250 μm average cell diameter in an inner layer, wherein said foamed cells are independent of a continued phase of resin and wherein the foamed layer is sandwiched by the non-foamed structure. When the non-foamed skin layer in the surface layer is less than 100 μm, no good appearance is achieved while, when there is a skin layer of more than 800 μm, specific gravity of the foamed layer becomes too low whereby it is not possible to prepare a foamed structure having specific gravity of 0.2 to 1.0 in a homogeneous cell state as a whole.

In a process for preparing the foam molded body of the present invention, chemical foaming agent and/or inert gas in a supercritical state to be filled in a metal mold together with the melted resin are/is added to the resin melted in a resin melting zone of a molding machine as a gas component which has a function of a foaming nucleus or a generating source thereof. To be more specific, as the chemical foaming agent, there may be used, for example, an inorganic compound such as ammonium carbonate or sodium bicarbonate and an organic compound such as azo compound or sulfohydrazide compound. As to the above azo compound, there may be exemplified diazocarbonamide (ADCA), 2,2-azoisobutyronitrile, azohexa-hydrobenzonitrile and diazoaminobenzene. Among them, ADCA is preferred and is commonly used. As to the above sulfohydrazide compound, there may be exemplified benzene sulfohydrazide, benzene 1,3-disulfohydrazide, diphenyl sulfone-3,3-disulfonehydrazide and diphenyl oxide-4,4-disulfonehydrazide. As to the above nitroso compound, there may be exemplified N,N-dinitrosopentaethylenetetramine (DNPT) and N,N-dimethyl terephthalate. As to the above azide compound, there may be exemplified terephthalazide and p-tert-butylbenzazide.

Further, as to the chemical foaming agent used herein, it may be used by mixing with polyamide resin (A) and/or (B) as a master batch of the foaming agent comprising a thermoplastic resin having a melting point lower than the decomposition temperature of the foaming agent as a base material, so as to homogeneously disperse the chemical foaming agent in the crystalline polyamide resin (A). The thermoplastic resin to be used as the base material may be used without any particular limitation provided that its melting point is lower than the decomposition temperature of the foaming agent and examples thereof are polystyrene (PS), polyethylene (PE) and polypropylene (PP). As to a compounding ratio of the foaming agent to the thermoplastic resin, it is preferred to be 10 to 100 parts by mass of the foaming agent to 100 parts by mass of the thermoplastic resin. When the ratio is less than 10 parts by mass, amount of the master batch to be mixed with the polyamide resin (A) is too much causing a lowering of physical property. When it is more than 100 parts by mass, it is difficult to prepare the master batch in view of the dispersibility of the foaming agent.

Amount of carbon dioxide and/or nitrogen in a supercritical state as a foaming agent is preferred to be 0.05 to 30 part (s) by mass and more preferred to be 0.1 to 20 part (s) by mass to 100 parts by mass of the polyamide resin composition. When the foaming agent is less than 0.05 part by mass, it is not possible to give homogeneous and fine foamed cells while, when it is more than 30 parts by mass, appearance of the surface of the molded body becomes poor whereby it is not possible to give a molded body having good appearance.

The carbon dioxide or nitrogen in a supercritical state used as a foaming agent may be used solely or may be used by mixing carbon dioxide with nitrogen. To a polyamide, there is a tendency that nitrogen is suitable for forming finer cells while carbon dioxide allows relatively large amount of gas injection whereby carbon dioxide is suitable for achieving a high foaming magnification. Therefore, carbon dioxide and nitrogen may be freely mixed depending on the prepared foamed structure state. The mixing ratio in this case is preferred to be within a range of from 1:9 to 9:1 in terms of molar ratio.

As to a method wherein a polyamide resin composition in a melted state is mixed with carbon dioxide or nitrogen in an injection molding machine, examples thereof are a method wherein gaseous carbon dioxide and/or nitrogen are/is infused either directly or in a pressurized state and a method wherein liquid carbon dioxide and/or nitrogen are/is infused using a plunger pump. It is necessary that the carbon dioxide and/or nitrogen as such are/is in a supercritical state in the molding machine in view of solubility, permeability and dispersibility thereof into the polyamide resin composition in a melted state. The term reading a critical state used hereinabove stands for such a state wherein, in rising the temperature and the pressure of a substance generating a gas phase and a liquid phase, discrimination between the gas phase and the liquid phase cannot be achieved in a certain temperature region and pressure region. The temperature and pressure at that time are called critical temperature and critical pressure, respectively. Thus, since a substance has the characteristics of both gas and liquid in a critical state, a fluid being resulted in such a state is called a critical fluid. The critical fluid as such has higher density and lower viscosity as compared with gas and liquid, respectively and, accordingly, it has highly diffusible property in a substance. Incidentally, critical temperature and critical pressure of carbon dioxide are said to be 31.2° C. and 7.38 MPa, respectively. In the case of nitrogen, critical temperature and critical pressure thereof are said to be 52.2° C. and 3.4 MPa, respectively. At the critical temperature or the critical pressure as such or higher than that, a critical state is resulted and there is achieved the behavior as a critical fluid.

Due to its excellent characteristic property, the foam molded body of the polyamide resin prepared by the present invention can be used as automobile-related parts. Examples of the automobile-related parts are interior equipment, exterior equipment, covers, case and load-supporting parts. Said foam molded body is used particularly preferably for a heat-resisting cover such as engine cover, cylinder head cover and transmission cover.

### Examples

As hereunder, the present invention will be more specifically illustrated by referring to Examples although the present invention is not limited to those Examples. Incidentally, the measured values mentioned in Examples are measured according to the following methods.

[Materials, Preparing Methods of Materials and Measuring Methods]

[Number-Average Molecular Weight]

Each sample (2 mg) was weighed, dissolved in 4 ml of 10 mM HFIP/sodium trifluoroacetate and filtered using a membrane filter of 0.2 μm. The resulting sample solution was subjected to a gel permeation chromatographic (GPC) analysis under the following conditions.
Apparatus: TOSOH HLC-8220GPC
Column: TSKgel SuperHM-H×2, TSKgel SuperH2000
Flow rate: 0.25 ml/minute; concentration: 0.05% by mass; temperature: 40° C.; detector: RI
Molecular weight conversion was calculated by means of a standard poly(methyl methacrylate) conversion.
With regard to molecular weight, it was calculated after removing that of 1000 or less as an oligomer.

[Melting Point (Tm) and Crystallization Temperature (Tc2)]

A sample of polyamide molded body which was dried in vacuo at 105° C. for 15 hours was weighed (10 mg) in a pan made of aluminum (manufactured by TA Instruments; catalog number: 900793.901) and made in a tightly-sealed state using a cover made of aluminum (manufactured by TA Instruments; catalog number: 900794.901). The resulting sample for the measurement was heated using a differential scanning calorimeter DSCQ 100 (manufactured by TA INSTRUMENTS) at the rate of 20° C./minute from room temperature and kept at 350° C. for 3 minutes. Then, the pan for the measuring sample was taken out and dipped in liquid nitrogen to quickly cool. After that, the sample was taken out from liquid nitrogen, allowed to stand at room temperature for 30 minutes and again heated using the differential scanning calorimeter DSCQ 100 (manufactured by TA INSTRUMENTS) at the rate of 20° C./minute from room temperature up to 350° C. and the peak temperature of endothermic change due to melting at that time was adopted as the melting point (Tm (20° C./minute)). It was then cooled down to 300° C. at the rate of 80° C./minute, held for 5 minutes and then cooled down to 23° C. at the rate of 20° C./minute or 10° C./minute. The Tc2 when cooling down at 20° C./minute was called Tc2 (20° C./minute) and the Tc2 when cooling down at 10° C./minute was called Tc2 (10° C./minute).

[Polyamide Resin]

(A) Crystalline polyamide resin

(a1) Polyamide 6 having relative viscosity RV of 2.4, (“Toyobo Nylon T-840”), number-average molecular weight: 17700

(a2) Polyamide 6 having relative viscosity RV of 1.9, (“Toyobo Nylon T-860”), number-average molecular weight: 14400

(a3) Polyamide 6 having relative viscosity RV of 3.1, (“Toyobo Nylon T-820”), number-average molecular weight: 25400

[Carbon Black]

(B) Carbon black master batch

(b1) Carbon black master batch for general purpose, (“EPC 8E 313” manufactured by Sumika Color, master base=LDPE resin)

(b2) Carbon black master batch for general purpose, (“PAB8K500” manufactured by Sumika Color, master base=AS resin)

(b3) Special carbon black master batch, (“EPC840” manufactured by Sumika Color, master base=LDPE resin)

(b4) Special carbon black master batch, (“PEC-TT1617” manufactured by Resino Color, master base=LDPE resin)

[Inorganic Reinforcing Material]

(c1) Glass fiber-1: CS 3PE 453 (Nitto Boseki)

(c2) Glass fiber-2: CSG 3PA 810S (Nitto Boseki)

(c3) Glass beads: GB 731A-PN (Potters-Ballotini)

[Others: Additives]

Stabilizer: Irganox B 1171 (BASF)

Mold-releasing agent: Montanoic acid ester wax WE 40 (Clariant Japan)

[Injection Molding Machine; Size of Molded Body]

Molding was conducted using an electric injection molding machine manufactured by Japan Steel Works under the following conditions.

Maximum clamping force: 1800 kN

Screw diameter: 42 mm (L/D=30)

Metal mold size: Flat plate of 100 mm width×250 mm length×2 mmt thickness

(It is possible to adjust the thickness within 2 mm+ core back amount (mm) while width and length were kept same by means of expansion of metal mold volume using core back.)

[Improving Rate of Load Resistance]

A non-foam molded body of polyamide molded by a flat metal mold of 100 mm width×250 mm length×2 mmt thickness and a foam molded body of polyamide prepared by core back expansion of cavity under a foaming condition in each of Examples and Comparative Examples were allowed to stand for 24 hours under the environment of 80° C. temperature and 95% humidity and then cut out into test pieces of 10 mm width×100 mm length. The resulting cut-out test pieces were subjected to a three-point bending test under 50 mm span length and 2 mm/minute load rate and the maximum load of non-foam molded body, and the maximum load of foam molded body resulted thereby were defined X(N) and Y(N), respectively. When the ratio of Y(N)/X(N) was 1.5 or more, the improving rate of load resistance thereof was marked “O”. When the ratio was not less than 1 and less than 1.5, the improving rate was marked “Δ”. When the ratio was less than 1 or when the upper foamed layer was hollow whereby lower skin layer and foamed layer were not destroyed at the same time but only upper skin layer was destroyed, the improving rate of load resistance was marked “x”.

[Homogeneity of Cell; Cell Diameter]

In photographic pictures taken by a scanning electron microscope, the case wherein an average cell diameter of optional three points in 500 to 2000 μm square covering at least twenty adjacent cells was 300 μm or less and wherein there was no cavity having continued length of 800 μm or more was marked “O” and the case other than that was marked “x”. A sample for a cross section observation was prepared by polishing after embedding into a visible ray-curable resin. Alternatively, a sample for a cross section observation was prepared by adjusting a molded body in such a manner that notch was previously formed so as to expose the foam cross section by breakage, and by dipping the molded body for 10 minutes in liquid nitrogen followed by subjecting to impact breakage so that the foam cross section was exposed. With regard to the above sample, the photographic picture of the cross section of foam molded body was taken by a scanning electron microscope, and subjected to an image processing. Diameter of equivalent circle of the cell calculated from at least 100 adjacent cells was defined a cell diameter. An average value obtained by a three-point measurement thereof was defined an average cell diameter. When the homogeneity of the cell was “x” and there was a cavity having continued length of 800 μm or more, measurement of the average cell diameter was judged to be impossible.

[Skin Layer Thickness]

A sample for a cross section observation was prepared by polishing after embedding into a visible ray-curable resin. Alternatively, a sample for a cross section observation was prepared by adjusting a molded body in such a manner that notch was previously formed so as to expose the foam cross section by breakage, and by dipping the molded body for 10 minutes in liquid nitrogen followed by subjecting to impact breakage so that the foam cross section was exposed. With regard to the above sample, the photographic picture of the cross section of foam molded body was taken by a scanning electron microscope. In the photographic picture, thickness of a non-foam layer which was unified with the surface layer part in an observation of the foam cross section was measured as a skin layer thickness.

[Specific Gravity]

Sample pieces each being 25 mm×25 mm× thickness having cut-out planes on four sides were cut out from a foam molded body and specific gravity thereof was measured according to a method for measuring the specific gravity of a solid (JIS Z 8807). When a foam layer was not fully formed but upper and lower skin layers were separated in a sandwich structure of skin layer/foam layer/skin layer, measurement of specific gravity was conducted at the same time for the cut-out test pieces divided into plural.

[Appearance]

Grain part of the above-mentioned molded body was evaluated by naked eye and the case wherein the filler such as glass was floated on the surface resulting in much unevenness of the surface being different from the grain shape or wherein depression, silver or flash visible by naked eye was noted, it was marked “x”. The case wherein there was no unevenness due to floating, etc. of the filler on the surface besides the unevenness of the grain and wherein the surface was beautiful without poor appearance such as silver or flash visible by naked eye, it was marked “O”.

[Method for Producing Polyamide Resin Compositions of Examples and Comparative Examples]

Each of the above materials was weighed according to the compounding ratio as shown in Table 1, wherein other additives were 0.4 part by mass of stabilizer and 0.4 part by mass of mold-releasing agent to 100 parts by mass of the composition ((A)+(B)+(C)). A mixture thereof except for the inorganic reinforcing material (C) was simultaneously poured from a hopper into a 35ø biaxial extruder (manufactured by Toshiba Machine) wherein cylinder temperature was 280° C. and screw revolutions were 100 rpm. Then, the mixture was melted and kneaded, and an inorganic reinforcing material (C) was poured using a side feed. A strand discharged from the extruder was cooled in a water tank, made into pellets using a strand cutter and dried at 125° C. for 5 hours to give pellets of the polyamide resin composition.

With regard to carbon black, a master batch was used, but the compounding amount shown in Table 1 was that in terms of carbon black.

[Preparation of Foam Molded Body of Polyamide Resin]

As noted by a brief constitutional drawing shown in FIG. 2, plasticization was conducted by setting the cylinder temperature at 290 to 310° C. in a plasticizing region of an electric injection molding machine having a screw of L/D=30, 42 mm diameter and 1800 kN clamping force. Nitrogen in a critical state was infused thereinto in an amount as shown in Table 1. The resulting composition was injected and filled in a metal mold adjusted at 100° C. surface temperature and, at the stage when non-foamed skin layer of 100 to 800 μm was formed by an injecting outer pressure and a foaming pressure from inside, a metal mold in a core side was moved in a mold-opening direction and volume of the cavity was expanded to volume of the foam molded body to give a foam molded body. As to the metal mold, there was used a metal mold for a flat plate preparation of 100 mm width, 250 mm length, 2 mmt thickness and core back amount (mmt), which can expand the cavity volume by moving the metal mold in the core side in a mold-opening direction.

### Examples 1 to 6 and Comparative Examples 1 to 5

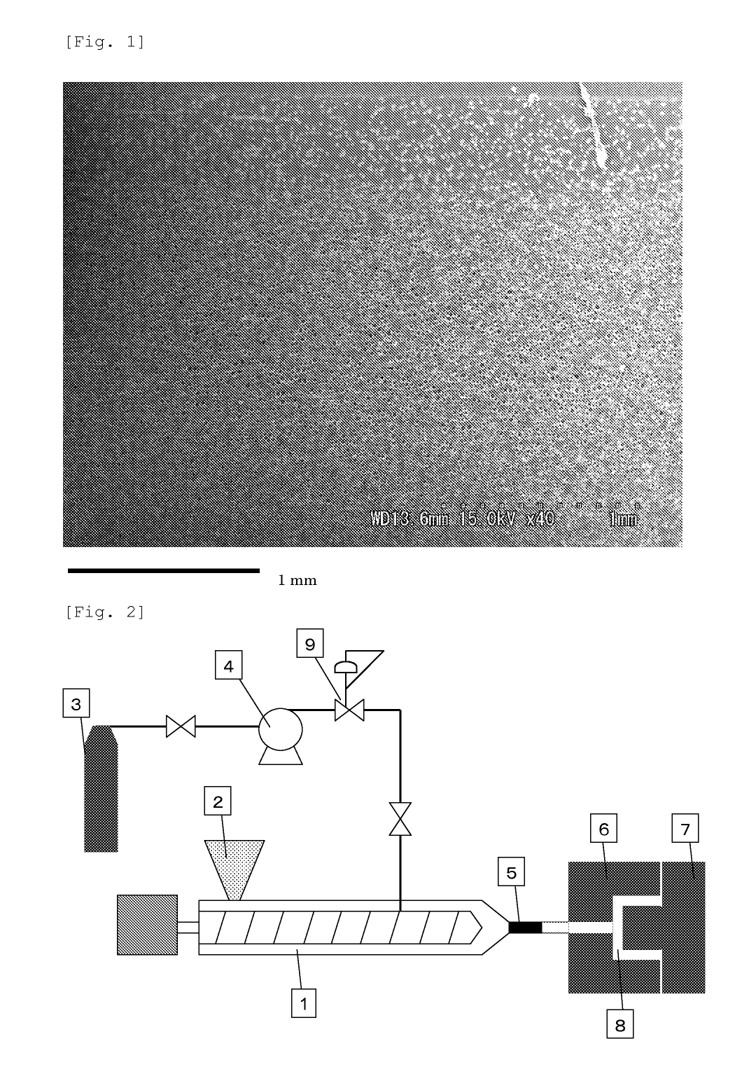

Table 1 shows the result of evaluation for the foam molded body of the polyamide prepared in Examples 1 to 6 and Comparative Examples 1 to 5. FIG. 1 is a cross sectional picture of the foam molded body of the polyamide resin of Example 1.

TABLE 1

| | | | | | | | | | | Com- | Com- | Com- | Com- | Com- |
|---|---|---|---|---|---|---|---|---|---|---|---|---|---|---|
| | | | | | | | | | | para- | para- | para- | para- | para- |
| | | | | | | | | | | tive | tive | tive | tive | tive |
| | | | | Exam- | Exam- | Exam- | Exam- | Exam- | Exam- | Exam- | Exam- | Exam- | Exam- | Exam- |
| | | | | ple 1 | ple 2 | ple 3 | ple 4 | ple 5 | ple 6 | ple 1 | ple 2 | ple 3 | ple 4 | ple 5 |
| (A) | a1 | T-840 | parts | | | 69 | 69 | 69 | 78 | | | 69 | | |
| | | | by mass | | | | | | | | | | | |
| | a2 | T-860 | parts | 69 | 69 | | | | | 69 | | | | |
| | | | by mass | | | | | | | | | | | |
| | a3 | T-820 | parts | | | | | | | | 69 | | 69 | 69 |
| | | | by mass | | | | | | | | | | | |
| (B) | b1 | EPC8E313 | parts | | | | | | | 1 | | | 1 | |
| | | | by mass | | | | | | | | | | | |
| | b2 | PAB8K500 | parts | | | | | | | | 1 | 1 | | 1 |
| | | | by mass | | | | | | | | | | | |
| | b3 | EPC840 | parts | 1 | | | 1 | | | | | | | |
| | | | by mass | | | | | | | | | | | |
| | b4 | PEC-TT1617 | parts | | 1 | 1 | | 1 | 2 | | | | | |
| | | | by mass | | | | | | | | | | | |
| (C) | c1 | CS3PE453 | parts | 30 | 30 | | 30 | | 20 | 30 | 30 | | 30 | |
| | | | by mass | | | | | | | | | | | |
| | c2 | CSG3PA810S | parts | | | 30 | | | | | | 30 | | 30 |
| | | | by mass | | | | | | | | | | | |
| | c3 | GB731A-PN | parts | | | | | 30 | | | | | | |
| | | | by mass | | | | | | | | | | | |

| | | | | | | | | | | | | | |
|---|---|---|---|---|---|---|---|---|---|---|---|---|---|
| | stabilizer | parts | 0.4 | 0.4 | 0.4 | 0.4 | 0.4 | 0.4 | 0.4 | 0.4 | 0.4 | 0.4 | 0.4 |
| | | by mass | | | | | | | | | | | |
| | mold-releasing | parts | 0.4 | 0.4 | 0.4 | 0.4 | 0.4 | 0.4 | 0.4 | 0.4 | 0.4 | 0.4 | 0.4 |
| | agent | by mass | | | | | | | | | | | |
| molding | nitrogen | wt % | 0.2 | 0.2 | 0.2 | 0.2 | 0.2 | 0.2 | 0.2 | 0.2 | 0.2 | 0.2 | 0.2 |
| condition | core back amount | mm | 1.3 | 1.3 | 1.6 | 1.6 | 1.6 | 1.6 | 1.3 | 1.3 | 1.6 | 1.6 | 1.6 |
| characteristic | molded body | mm | 2.6 | 2.6 | 3.2 | 3.2 | 3.2 | 3.2 | 1.8 | 1.5 | 2.9 | 2.8 | 2.8 |
| property | thickness | | | | | | | | | | | | |
| of | Tc2 (20° C./minute) | ° C. | 184 | 183 | 184 | 183 | 183 | 183 | 188 | 187 | 188 | 188 | 187 |
| molded | Tc2 (10° C./minute) | ° C. | 188 | 188 | 187 | 189 | 188 | 188 | 192 | 194 | 194 | 194 | 194 |
| body | Tm (20° C./minute) | ° C. | 222 | 224 | 223 | 222 | 223 | 223 | 224 | 222 | 223 | 223 | 222 |
| | Tm | ° C. | 38 | 41 | 39 | 39 | 40 | 40 | 36 | 35 | 35 | 35 | 35 |
| | (20° C./minute) − | | | | | | | | | | | | |
| | Tc2 (20° C./minute) | | | | | | | | | | | | |
| | specific gravity | | 0.65 | 0.65 | 0.64 | 0.64 | 0.64 | 0.52 | 1.28 | 1.32 | 1.11 | 1.10 | 1.00 |
| | appearance | by | ◯ | ◯ | ◯ | ◯ | ◯ | ◯ | ◯ | X | ◯ | X | X |
| | | naked | | | | | | | | | | | |
| | | eye | | | | | | | | | | | |
| | homogeneity of cell | | ◯ | ◯ | ◯ | ◯ | ◯ | ◯ | X | X | X | X | X |
| | skin layer thickness | μm | 510 | 487 | 430 | 460 | 511 | 454 | 832 | 667 | 620 | 780 | 680 |
| | improving rate of | | ◯ | ◯ | ◯ | ◯ | ◯ | ◯ | X | X | X | X | X |
| | load resistance | | | | | | | | | | | | |

As will be apparent from Table 1, the polyamide foam molded bodies of Examples 1 to 6 can give good black surface appearances and homogeneous and fine foamed cell structures and, as compared with a non-foam molded body, low specific gravity and big enhancement of load resistance can be achieved. On the other hand, as will be shown in Comparative Examples 1 to 5, no homogeneous foamed layer is achieved when no specific carbon black is used, and not only the appearance of the molded body cannot be made into a good state but also anti-vibration property may not be enhanced due to heterogeneous cavity in the formed layer. Accordingly, the products of Comparative Examples 1 to 5 were inferior in any of evaluating times as compared with the products of Examples 1 to 6.

### INDUSTRIAL APPLICABILITY

The polyamide foam molded body of the present invention gives a foam molded body having heat-resistance and also having light weight and high load bearing property without deteriorating the excellent physical property and characteristic property of polyamide resin. Also, it is excellent in expressing a black appearance. Unlike a method for preparing a foam molded body which has been disclosed in the past, neither non-crystalline polyamide nor viscosity adjusting agent is used in terms of the composition in the present invention whereby the product can be produced at low cost. Accordingly, the polyamide foam molded body of the present invention not only can achieve weight reduction of automobile parts and household electric appliances but also can provide a molded body being excellent in anti-vibration property and heat insulation property specific to a foam molded body whereby it is useful.

### EXPLANATION OF REFERENCE NUMBER

1 Injection molding machine
2 Hopper
3 Gas canister
4 Boost pump
5 Opening-closing valve
6 Metal mold (stationary side)
7 Metal mold (core/operation side)
8 Cavity (molded body)
9 Pressure-controlling valve

1. A polyamide resin composition for a foam molded body, comprising a crystalline polyamide resin (A), carbon black (B) which does not exhibit crystallization promoting action to said crystalline polyamide resin and an inorganic reinforcing material (C), wherein, when the total amount of (A), (B) and (C) is taken as 100% by mass, the composition comprises (A) and (B) in a rate of 60 to 90% by mass in terms of the sum thereof and comprises (C) in a rate of 10 to 40% by mass, and wherein said polyamide resin composition satisfies the following characteristic property (a):
characteristic property(a):X−Y≧37° C.
wherein X is melting point (° C.) in DSC measurement (raising rate of temperature: 20° C./minute) of the polyamide resin composition; and
Y is crystallization temperature (Tc2)(° C.) in DSC measurement (lowering rate of temperature: 20° C./minute) of the polyamide resin composition.

2. The polyamide resin composition for a foam molded body according to claim 1, wherein the crystalline polyamide resin (A) is an aliphatic polyamide resin.

3. The polyamide resin composition for a foam molded body according to claim 1, wherein Y (Tc2) in the characteristic property (a) is 182 to 186° C.

4. The polyamide resin composition for a foam molded body according to claim 1, wherein the carbon black (B) is a black pigment which does not promote crystallization of the polyamide even when it is added in an amount of 0.1% by mass or more.

5. A foam molded body of polyamide resin prepared using the polyamide resin composition for a foam molded body mentioned in claim 1.

6. A foam molded body of polyamide resin prepared by such means that the polyamide resin composition for a foam molded body mentioned in claim 1 is melted, the polyamide resin composition in a melted state is injected and filled into a cavity formed of clamped plural metal molds together with chemical foaming agent and/or inert gas in a supercritical state, at least one metal mold in a core side is moved in a mold-opening direction at the stage when non-foamed skin layer is formed by an injecting outer pressure and a foaming pressure from inside, and volume of the cavity is expanded to volume of a foam molded body.

7. The foam molded body of polyamide resin according to claim 5, wherein the foam molded body of polyamide resin is for automobile-related parts.

8. The foam molded body of polyamide resin according to claim 7, wherein the automobile-related parts are one member selected from interior equipment, exterior equipment, covers, case and load-supporting parts.

9. The foam molded body of polyamide resin according to claim 7, wherein the automobile-related parts are heat-resisting covers which are any of engine cover, cylinder head cover and transmission cover.
